(19) United States
(12) Patent Application Publication
(10) Pub. No.: US 2003/0167400 A1
(43) Pub. Date: Sep. 4, 2003

(54) Key based register locking mechanism

(76) Inventor: Derek Coburn, Cong (IE)

Correspondence Address: NIXON & VANDERHYE P.C., 8th Floor, 1100 North Glebe Rd., Arlington, VA, 22201-4714, US

(21) Appl. No.: 10/216,170

(22) Filed: Aug. 12, 2002

(30) Foreign Application Priority Data
Mar. 1, 2002 (GB) 0204777.7

(51) Int. Cl. G06F 12/14

(52) U.S. Cl. 713/193

(57) ABSTRACT

A key based locking system for guarding against improper or invalid access to internal registers of a core. Two key values are held in at least one lock register and sequential writes of the first and second keys within a predetermined period are required to unlock access to a protected register. Access to the protected register may then be permitted for the rest of the clock cycle, or alternatively may be permitted until a lock command is received.

### FIELD OF THE INVENTION

This invention relates to protection of configurable systems from invalid register accesses.

### BACKGROUND OF THE INVENTION

In many system on chip (SOC) developments at least some core system critical services are configurable, and it is desirable that the configuration should not be changed by improper or invalid register accesses. Such accesses may occur, for example, subsequent to an embedded processor locking up (or crashing) and issuing random illegal register write requests to a core. This poses a threat of illegal reconfiguration of a core. This may be particularly hazardous if the core that is reconfigured has a safeguarding function, such as a watchdog timer, where the primary function of the timer, which to identify processor lock up may be disabled.

The problem is particularly acute in multiprocessor architecture where an illegal code sequence generated on one locked processor may complicate system recovery by reconfiguring other processor resources.

### SUMMARY OF THE INVENTION

According to the invention there is provided a register write access locking system, comprising a key register for holding two key values, a lock register and an access check that requires a write to the lock register of the first key, then a second write that includes the second key within a predefined period before a write to a protected register is allowed

The invention provides a key based hardware locking scheme for guarding against illegal processes gaining write access to internal control registers. A two stage process may be provided in which the second stage opens register access, programs the internal register and then locks access in a single write operation. This is useful when single or random accesses is the normal mode of operation and maximum protection is required

In an alternative process, access to internal registers may be placed in a locked or unlocked state, which is useful for core configuration requiring many register write accesses After the sequence of accesses, the registers are then locked again.

According to the invention there is provided a register write access locking system, comprising a key register for holding two key values, a lock register and an access check that requires a write to the lock register of the first key, then a second write that includes the second key within a predefined period before a write to a protected register is allowed

### BRIEF DESCRIPTION OF THE DRAWINGS

The invention is now described by way of example with reference to the drawings in which:

FIG. 1 is a datapath functional diagram showing a multiprocessor ASIC built using a system on chip architecture;

FIG. 2 is a control flow diagram for a register lock state machine for full key protected register accesses,

FIG. 3 is a control flow diagram for a register lock state machine for holding register access in a locked or unlocked state;

FIG. 4 is a diagram of a software process involved in initialization and control of a watchdog timer, and

FIG. 5 is a diagram of a state machine sequence for watchdog timer control logic.

### DETAILED DESCRIPTION OF PREFERRED EMBODIMENT

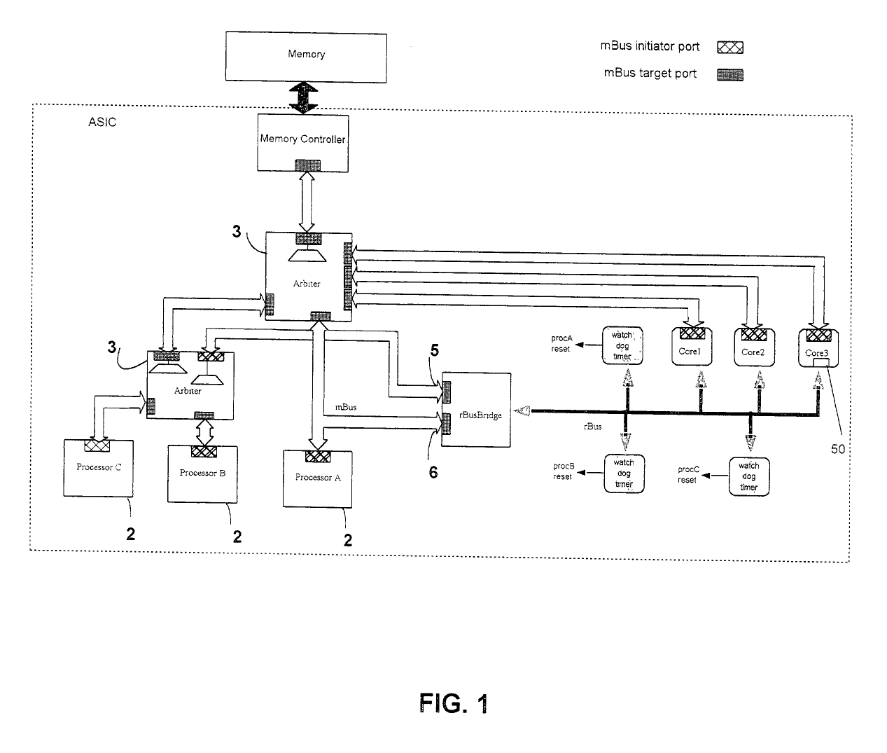

A general environment in which a protective locking mechanism may be required is schematically illustrated in the datapath functional diagram of FIG. 1. In FIG. 1 a plurality of hardware cores 1 (shown as Core 1, Core 2 and Core 3 and which may be of any suitable kind) and a plurality of embedded processors 2 (shown as Processor A, Processor B and Processor C) are embedded on an ASIC and all vie for access to shared off chip memory. The interconnection of the core and processor datapaths may be implemented, by databus technology and protocols, for example as described in UK patent application 0113584 7 filed Jun. 5, 2001. Data paths to memory are implemented using an mBus (memory bus) with aggregation of these datapaths being serviced by mBus arbiter blocks 3. Register access to the control and status registers within any one of the cores 1 is provided by means of a register bus (rBus) to the cores. An rBus bridge core serves the function of translating mBus transactions targeted at the core register space into rBus transactions. In the particular instance illustrated in FIG. 1, the rBus bridge enables the mBus initiator ports 5,6 to arbitrate for access to the rBus. With such an arrangement of direct rBus access, there is no safeguard against instances where a processor starts an illegal code sequence of random writes to memory, and as the core registers are mapped to memory such a process threatens possible reprogramming of the configuration of the cores.

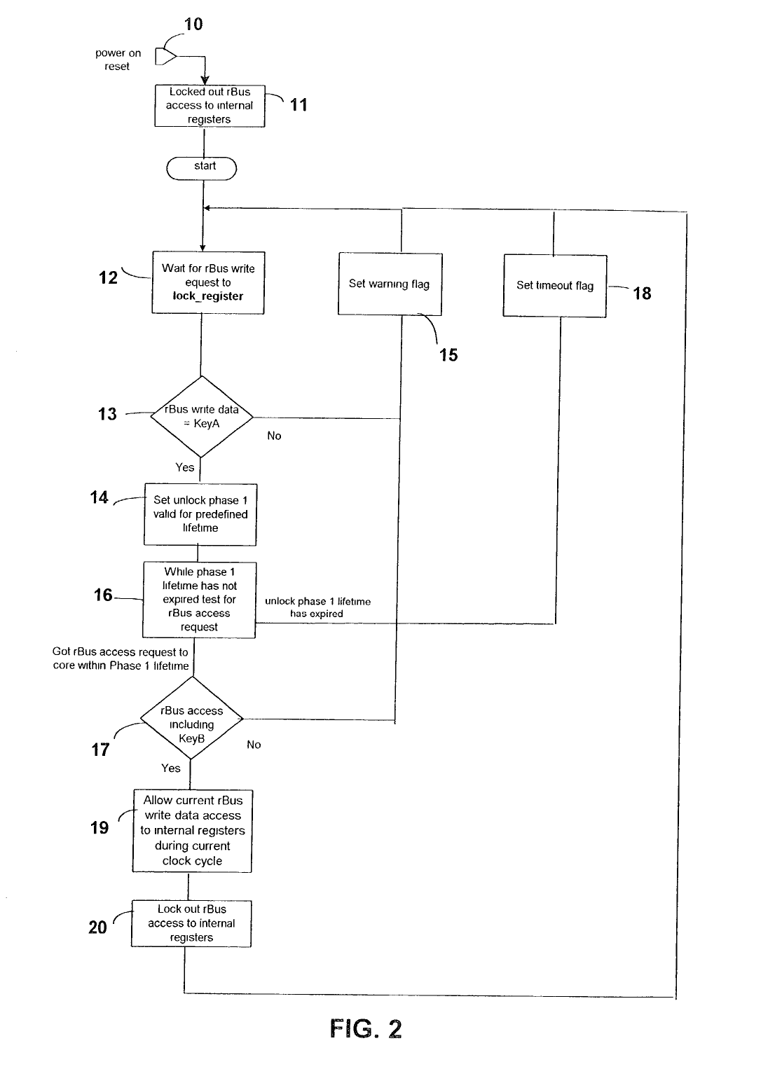

Referring now to FIG. 2 this shows the main elements of an algorithm implemented in a state machine to provide key based register locking. This functionality is provided within what is referred to in this specification as a lock state machine, and is the main block of logic that controls write access from the rBus to internal registers guarded by the system.

Table 1 (below) gives examples of typical principal registers associated with the register lock state machine.

The lock state machine has a Lock_Register and a Keys_Register which are used in the lock protection system and which protect access to control and status registers (CSR), a typical one of which is exemplified in Table 1.

TABLE 1

| Offset from | |
|---|---|
| Base Address | Register |
| 0x0000 | Lock_Register* |
| 0x0004 | Keys_Register* |
| 0x0008 | CSR Register 1 (internal reg) |
| | Other CSR regs (internal reg) |

Lock_Register (base + 0x0000)*

| | Bit | | Reset | |
|---|---|---|---|---|
| Name | No. | Type | Value | Description |
| Write bit | 31:4 | R/W | 0 | Write accesses are ‘detected’ |
| field padded | | | | but no data is stored**. |
| with zeros | | | | Bit field padded with zeros on |
| on Key write | | | | Key write (see below) |
| Lock_Register | 3:0 | R/W | 0 | Write accesses are ‘detected’ |
| [3:0] | | | | but no data is stored** |
| | | | | The Processor must write |
| | | | | KeyA to this register before it |
| | | | | can successfully write to |
| | | | | either KeysRegister, or |
| | | | | CSR registers. |

2) Keys_Register (base + 0x0004)*

| | Bit | | Reset | |
|---|---|---|---|---|
| Name | No. | Type | Value | Description |
| Unused | 31:12 | RO | 0 | |
| Key check field | 11:8 | R/W | 0 | For writes to be successful |
| | | | | this field must be written to |
| | | | | the current Value of KeyB.** |
| Reserved | | | | |
| KeyB[3:0] | 7:4 | R/W-on | 0 | Defines the Value of KeyB |
| | | valid key | | |
| KeyA[3:0] | 3:0 | R/W-on | 0 | Defines the Value of KeyA |
| | | valid key | | |

3) CSRI (base + 0x0010)

| | Bit | | Reset | |
|---|---|---|---|---|
| Name | No. | Type | Value | Description |
| Reserved | | | | |
| Key check field | 11:7 | R/W | 0 | For writes to be successful |
| | | | | this field must be written to |
| | | | | the current Value of KeyB.** |
| CSR register | 7:0 | R/W-on | 0 | Internal CSR register bits |
| bits | | valid key | | to be configured |

Other CSR registers follow a similar scheme.
**There is no storage for these bits and reads will return 0 for this field.

As shown in FIG. 2, the sequence starts with power-up and initial reset (reference 10), and write access from the rBus to internal registers within the protected core disabled (box 11). Read access is unaffected by the functioning of the lock state machine.

In this implementation, freeing register write access is a two stage process using two predefined bit patterns referred to herein as KeyA and Key B The first key, KeyA, is used in the initial phase of the unlock process and before the processor can access any of the registers guarded by the locking mechanism it must write KeyA to the lock register. Once a valid KeyA has been received, KeyB has to be contained in a Key check field that is part of the write to the register.

Reference 12 shows the state machine waiting for an rBus write request to the lock_register, and then (reference 13) it is determined whether the correct key bit pattern corresponding to KeyA has been provided to the lock register. If the correct KeyA bit pattern has been provided (Yes), then as shown by reference 14 an unlock phase is set for a predefined lifetime In the event that the rBus write data does not correspond to KeyA (no), a warning flag 15 is set and the system reverts to waiting for the KeyA write request 12..

KeyA is user configurable and need not be a full 32 bit bit pattern, and if it is not the remaining bits of the long word register write are padded with zeros. In the checking of the key, the state machine performs a full 32 bit compared with KeyA and the padded bit field in the write access

When a correct KeyA has been established and the first unlock phase of the process has started, the state machine then waits during the predefined lifetime for a register write access request (reference 16) to the core's internal registers and (reference 17) determines whethr it contains a valid Key B in the key check field. As with the check for KeyA, a failure in the Key B comparison (NO) will set the warning flag 15 as an illegal access event and return the state machine back to the reset state 12 waiting for KeyA. A read access at this stage rather than the Key B write will also trigger the warning flag and reset, as it is not the expected event. At this stage there is also a lapsed time check to see if the lifetime of the unlock phase started by KeyA has expired If the lifetime expires before Key B is received, a timeout flag 18 is set and the system again reset to wait for KeyA.

The check field for Key B is a series of bits in the rBus write data reserved to enable comparison between the key associated with the requested access and the predefined Key B. When the key check is confirmed (YES), the remainder of the rBus write data is programmed to the associated register bits within the core (reference 19). At the end of the clock cycle of the rBus data, the state machine automatically locks out rBus write access to the internal registers and returns to the reset state where it is available to service other register access requests (reference 20).

The phase 1 unlock state, after receipt of correct KeyA, has an unlock lifetime chosen to correspond to the maximum valid time interval for consecutive processor rBus accesses to the core as viewed on the core's local rBus. This allows for the time delay between rBus write accesses as introduced by the mBus and rBus arbitration path from the processor to the core for the particular ASIC design

It will be appreciated that the KeyA, Key B locking scheme and time out feature requires a processor to issue consecutive accesses in the correct order with the correct key combination. The timeout feature also serves as a way of monitoring the maximum processor to rBus latency. A typical timeout interval that might currently be configured for the locking scheme is 1 microsecond, which is greater than the arbitration latencies for most systems.

The bit patterns of KeyA and Key B are user configurable and are held in the keys register which is itself protected by the key locking system. On power up and initial reset, the bit patterns for both keys are initialized with a value of zero. To define new values, the keys having the old values are used to gain write access by writing KeyA to the lock_register, immediately followed by a register write by the processor to the key_register with rBus write data. This write to the key register is handled in the same way as a write to any other protected register as has been described with reference to FIG. 2. The register write access has the form:

Key check field:

Write data [11:8]=(old) Key B

Data field:

Write data [7:4]=New Key B

Write data [3.0]=New KeyA

This follows the exemplary form of the registers shown in Table 1.

The location of the key check field within the rBus data and the length of the keys may vary from the above format and be changed to suit the software or hardware engineering requirements.

Using two 4-bit keys to protect 4 registers in a 32 bit architecture and assuming the processor issues a series of register writes to random addresses in memory space with random bit patterns in the data word, the probability of the processor gaining access following two consecutive writes to memory space (an unlikely occurrence in the first instance) is of the order of 1.35×10⁻²⁰ Use of longer keys would increase the level of protection, which may be desirable where large numbers of registers are guarded, which increases the likelihood of false accesses.

In the scheme described, the second phase of the unlock operation with Key B and the write to the register occur in the same 32 bit rBus access request, after which write access is automatically locked again.

However, there are instances where it is useful to hold register access in a locked or unlocked state. This may be the case when a large number of consecutive register write accesses are required, or large numbers of registers are protected. In a second modified implementation of the key locking system, the keys may be used to open access to the registers for the series of multiple register writes and close access after completion of the series of writes, rather than issue multiple two-phase register accesses.

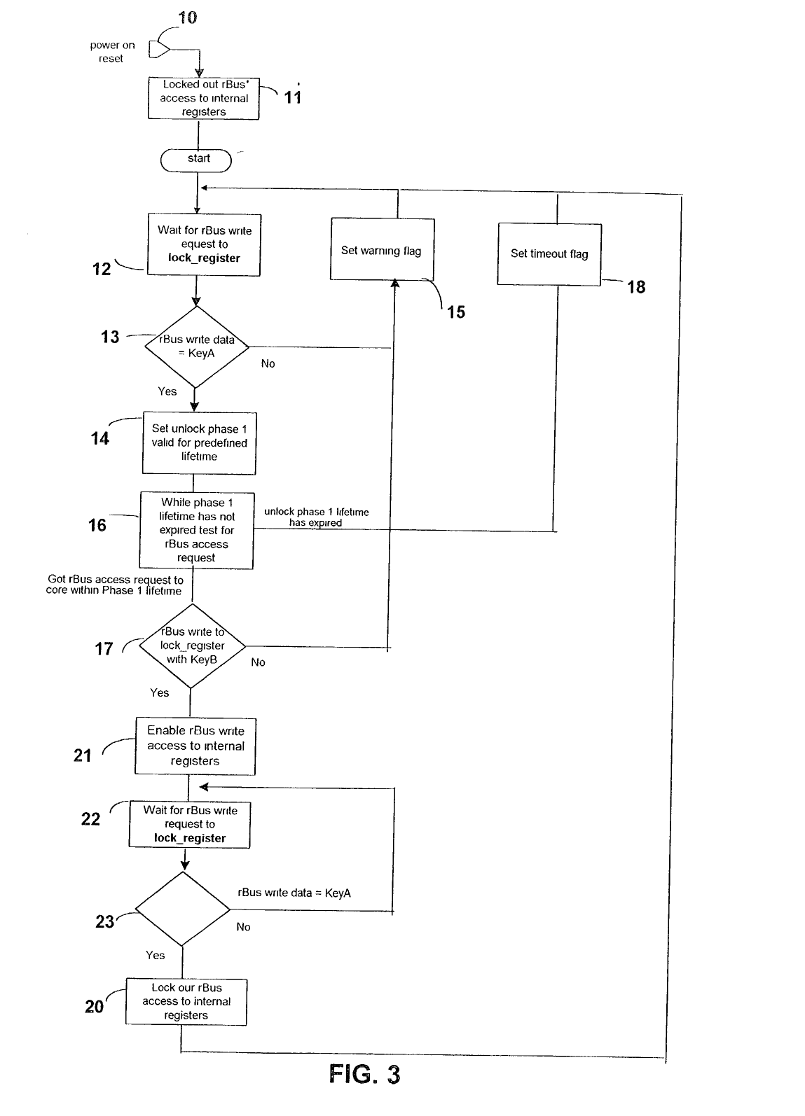

FIG. 3 shows a flow chart for a modified process in which access to the registers is gained by consecutive writes of KeyA and Key B, both to the lock_register, which unlocks access to the bank of registers until such time as a further KeyA write is performed to the lock register to return the state machine to its locked state.

It will be seen that FIG. 3 is similar to FIG. 2 up to and including the phase 1 unlock lifetime However then, during that unlock lifetime, instead of testing for rBus access write data including Key B, the test is for an rBus access request to write to the lock_register and for a write of Key B. When this is yes rBus write access to internal registers is enabled (reference 21) and these stay open for access until closed by a further key write. The state machine waits for a further rBus write request to the lock_register (reference 22) and then tests (reference 23) for whether this is KeyA. If yes, then the registers are locked, if no waiting continues. It will be appreciated that with this modification, the registers are open for an indefinite time for multiple accesses, rather than being automatically locked as happens the FIG. 2 embodiment. When rBus write data for the lock register of KeyA occurs, lock out and return to reset occurs.

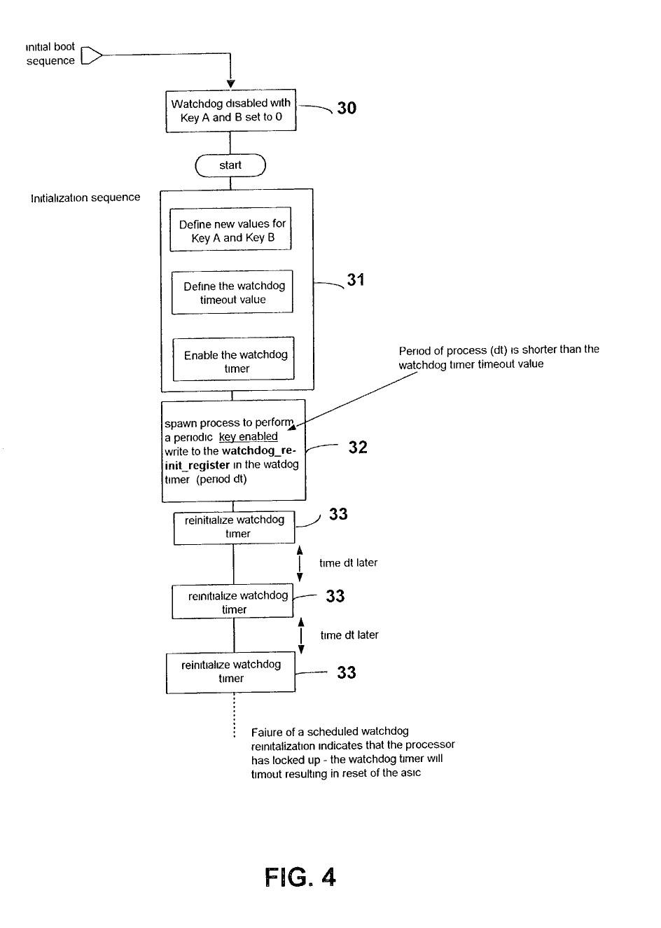

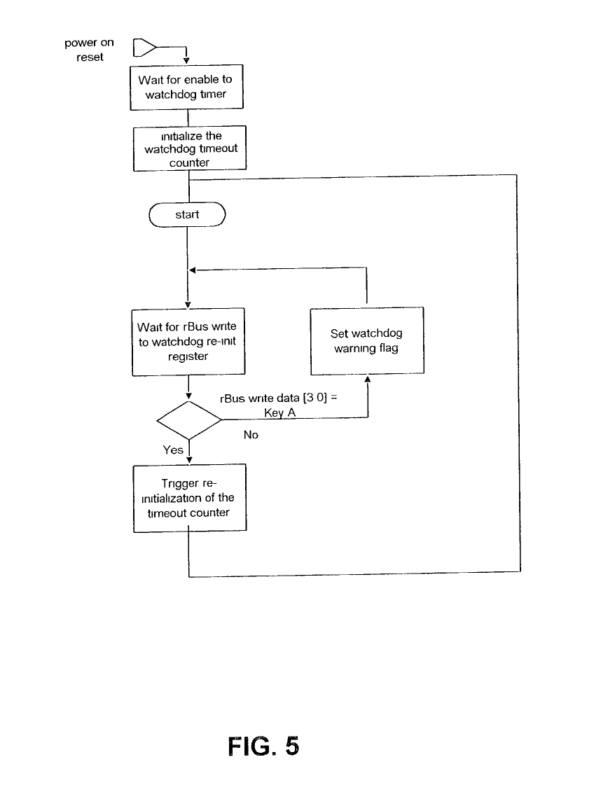

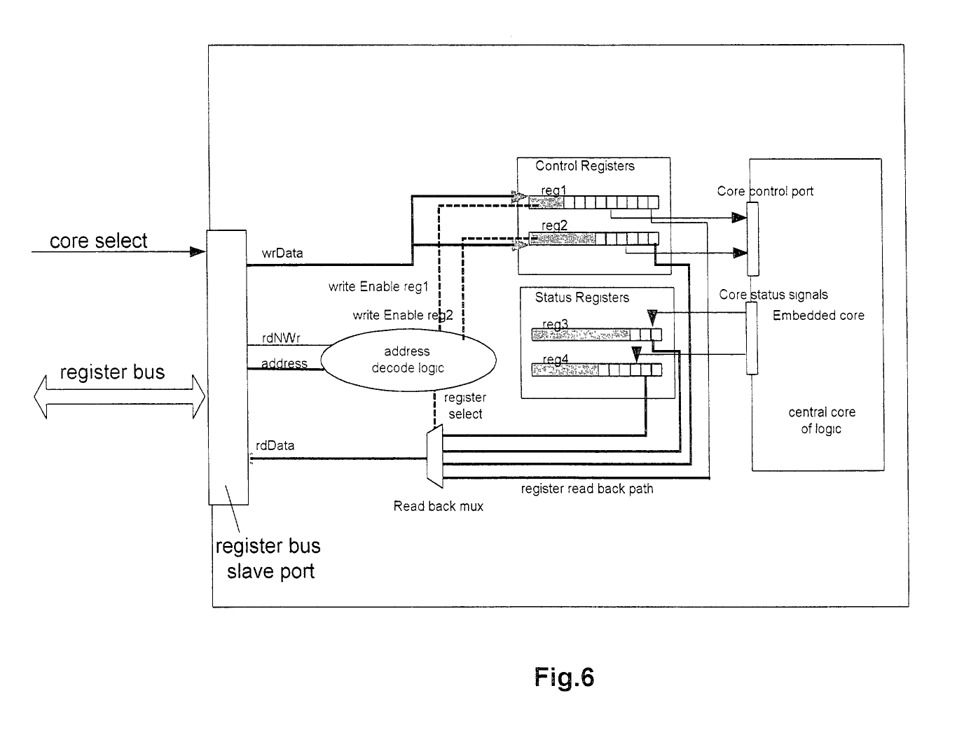

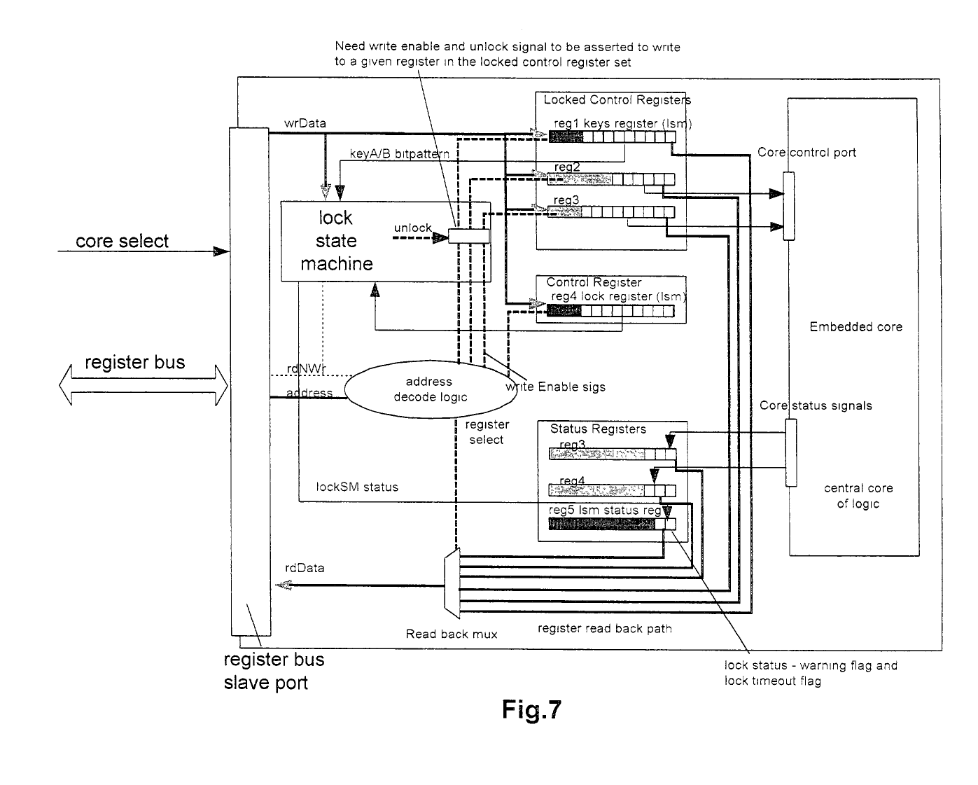

A practical application of the scheme is now described in relation to FIGS. 4 and 5 in the context of a watchdog timer FIGS. 6 and 7 show where, the lock state machine may be located within the logic blocks of a control and status register of a core to the CPU register bus.

A watchdog timer provides a basic timer that times out and asserts an output if it is not periodically written to by the processor that it is assigned to monitor. The timeout value is usually programmable over a range of values to provide flexibility of use. It is desirable to prevent illegal writes from a processor effecting the watchdog timer, such illegal writes may originate from the assigned processor core or from another processor in the system Implementing the key locking system will prevent illegal access to the internal registers of the timer.

Referring to FIG. 4 and Table 2 the sequence for intializing and controlling a key protected watchdog timer is shown

TABLE 2

| | Offset from | |
|---|---|---|
| | Base Address | |
| Address [4:0] | (Hex) | Register |
| 5′b00000 | 000 | Lock_Register |
| 5′b00100 | 004 | Keys_Register |
| 5′b01000 | 008 | TimerValue |
| 5′b01100 | 00C | WDReset |
| 5′b10000 | 010 | WDCSR |
| 5′b10100-5′b11100 | | Unused |

Lock_Register (base + 0x0000)

| | Bit | | Reset | |
|---|---|---|---|---|
| Name | No. | Type | Value | Description |
| Unused | 31:4 | RO | 0 | |
| Lock_Register | 3:0 | R/W-on | 0 | There is no actual storage for |
| [3:0] | | key valid | | writes to this register and |
| | | | | reads will always return 0. |
| | | | | (Write accesses are ‘detected’ |
| | | | | but no data is stored). |

Keys_Register (base + 0x0004)

| | Bit | | Reset | |
|---|---|---|---|---|
| Name | No | Type | Value | Description |
| Unused | 31:12 | RO | 0 | |
| Key check field | 11:8 | R/W | 0 | For writes to be successful |
| | | | | this field must be written to |
| | | | | the current Value of KeyB.* |
| KeyB[3:0] | 7:4 | R/W on | 0 | Defines the Value of KeyB |
| | | key valid | | |
| KeyA[3:0] | 3:0 | R/W on | 0 | Defines the Value of KeyA |
| | | key valid | | |

TimerValue (base + 0x0008)

| | Bit | | Reset | |
|---|---|---|---|---|
| Name | No | Type | Value | Description |
| Unused | 31:27 | RO | 0 | |
| CurrentTime | 26:16 | R/O | 0 | Provides a read back path for |
| | | | | the current value of the timer. |
| Unused | 15:12 | R/O | 0 | |
| Key check field | 11:8 | R/W | 0 | For writes to be successful |
| | | | | this field must be written to |
| | | | | the current Value of KeyB. |
| Unused | 7:4 | RO | 0 | |
| TimerValue | 3:0 | R/W-on | 0 | Selects the Timeout Value-4 |
| | | key Valid | | bit code for timeout select |

WDReset base + 0x000C

| | Bit | | Reset | |
|---|---|---|---|---|
| Name | No | Type | Value | Description |
| Unused | 31:4 | RO | 0 | |
| Key check | 11:8 | R/W | 0 | For writes to be successful |
| field | | | | this field must be written to |
| | | | | the current Value of KeyB. |
| | | | | There is no storage for these |
| | | | | bits and reads will return |
| | | | | 0 for this field. |
| Unused | 7:1 | RO | 0 | |
| Re_Initialise | 0 | R/W-on | | A write of 1 re-initializes the |
| timer | | key valid | | watchdog timeout counter.* |

WDCSR (base + 0x0010)

| | Bit | | Reset | |
|---|---|---|---|---|
| Name | No. | Type | Value | Description |
| Unused | 31:12 | RO | 0 | |
| Key check | 11:8 | RO/W | 0 | For writes to be successful |
| field | | | | this field must be written to |
| | | | | the current Value of KeyB. |
| | | | | There is no storage for these |
| | | | | bits and reads will return |
| | | | | 0 for this field. |
| Unused | 7:3 | RO | 0 | |
| WrTimerEn | 3 | R/W-on | 0 | TEST MODE |
| | | key valid | | When Set, Writes to the upper |
| | | | | 11 bits of the TimerValue |
| | | | | Register will preset the Timer |
| | | | | Register. |
| TimeOut | 2 | RO | 0 | Indicates if a timeout has |
| | | | | occurred. Set by the hardware |
| | | | | when a timeout event occurs |
| | | | | Cleared by Reset, not cleared |
| | | | | by another reset source. |
| | | | | Cleared by writing 1 to the |
| | | | | ClearTimeOut field of this |
| | | | | register. |
| ClearTimeOut | 1 | R/W-on | 0 | To clear the Timeout Bit, |
| | | key valid | | this field must be written |
| | | | | to a 1.* |
| WdEn | 0 | R/W-on | 0 | Watchdog Enable bit. Must be |
| | | key valid | | set to one to enable the Timer. |

The watchdog is initially booted to a disabled state with KeyA and KeyB both set to zero (reference 30). The basic intialization process (reference 31), which is a three stage process, then takes place

Stage 1. KeyA, currently zero, is written to the Lock Register, then KeyB (also zero) is written to the Key Register and new keys defined by

Key check field Data [11.8]=(old) KeyB

$$\begin{matrix}Key check field & Data [ 11.8 ] & = & ( old ) KeyB \\ Register bit field & Data [ 7 \text{:} 4 ] & = & New KeyB \\ & Data [ 3 \text{:} 0 ] & = & New KeyA\end{matrix}$$

Stage 2. Then using the new keys the time out value is set by

write KeyA to the Lock Register

write to the Timer Value register with

Key check field Data [11:8]=Key B

Register bit field Data [3:0]=Time value

Stage 3 Then the watchdog timer is enabled in a similar way

Write KeyA to the Lock Register

Write to the WDCSR register with

Key check field Data [11:8]=KeyB

Register bit field Data [0]=1 (set enable bit)

To reset the watchdog timer, the processor must access the watchdog timer periodically to prevent timeout. The timer is reinitialised in the WDReset register, again using the two key process.

Write KeyA to the Lock Register

Write to the WDReset register

Key check field Data [11:8]=KeyB

Register bit field Data [0]=(trigger reinitilisation of watchdog timeout counter)

This is shown in stages 32 and 33, with the reinitialisation occurring every period dt during proper functioning

The state machine sequence for this is shown in FIG. 5.

The watchdog core may, for example, be one of the watchdog cores shown in FIG. 1. Each of the cores will have interface logic between the rBus and core which, schematically, may be regarded as located at the location 50 shown on Core 3 of FIG. 1

FIG. 6 shows an interface without Key protected registers and FIG. 7 shows an example of where the lock state machine may be located within such a configuration.

1. A register write access locking system, comprising a key register for holding two key values, a lock register and an access check that requires a write to the lock register of the first key, then a second write that includes the second key within a predefined period before a write to a protected register is allowed

2. A system according to claim 1 in which the second write is to a register to which access is requested and when the second key is received access to the register is permitted for the current clock cycle.

3. A system according to claim 1 in which the second write is to the lock register and when the second key is received write access to the protected registers is permitted for a series of writes.

4. A system according to claim 3 in which write access to the protected registers is permitted until another key is written to the lock register
